(19) United States
(12) Patent Application Publication
(10) Pub. No.: US 2016/0023807 A1
(43) Pub. Date: Jan. 28, 2016

(54) Compact Pet Waste Disposal Device

(71) Applicants: Allen Prescott Tappan, Soldotna, AK (US); Joseph Matthew Spampinato, Bend, OR (US)

(72) Inventors: Allen Prescott Tappan, Soldotna, AK (US); Joseph Matthew Spampinato, Bend, OR (US)

(21) Appl. No.: 14/341,795

(22) Filed: Jul. 26, 2014

(51) Int. Cl. B65D 30/20; A01K 27/00

(52) U.S. Cl. CPC B65D 31/10; A01K 27/008

(57) ABSTRACT

The present device is a reusable, machine washable, compact, lightweight pet waste disposal sport pouch designed to conveniently provide hands free transport of used pet waste bags and carry useful supplies while securely attaching to a leash to minimize undesirable motion and thus facilitating extended pet walks and other vigorous activities like jogging and running Embodiments of the device include a collapsible, main pouch to carry used pet waste bags that has a rectangular shape with an open top, two inwardly pleated sides, and transitions to form a “V” shape at the bottom, multiple vertical leash attachment options to reduce device motion when attached to a leash, quick release connectors attached to stiffening material at the top of the main pouch which can be rolled down to and secured to leash handles for added stability as well as reduce the device size and potential escaping odors, finger loops near the top front and top back of the device to facilitate opening the device to accept a used pet waste bags, and accessory pockets on the front of the device to hold unused pet waste bags and other useful supplies.

### BACKGROUND

### Prior Art

U.S. Pat. Nos.

| Patent | Kind | | |
|---|---|---|---|
| number | Code | Issue Date | Patentee |
| *5,713,616 | A | 1998 Feb. 3 | Jan B Knudson |
| *6,237,533 | B1 | 2001 May 29 | Carol Rodriguez |
| 8,627,974 | B2 | 2014 Jan. 14 | Ajax Carl Francis |
| 5,829,671 | A | 1998 Nov. 3 | Richard B. Hawk |
| 3,885,266 | A | 1971 Sep. 1 | Betty O. Natzinger |
| 4,974,893 | A | 1990 Dec. 4 | Paul E. Grahn |
| 5,186,384 | A | 1992 Jan. 28 | Robert J. Nelson |
| 4,017,015 | A | 1976 Jan. 12 | Ray Jefferson |
| 6,964,247 | B1 | 2005 Nov. 15 | Hsun-Chin Lin |
| 1,485,172 | A | 1924 Feb. 26 | B. B. Dowell |
| 3,626,900 | A | 1971 Dec. 14 | Fred Falla |
| 4,017,015 | A | 1977 Apr. 12 | Ray Jefferson |
| 4,156,400 | A | 1977 May 27 | Jerome Migdal |
| 4,566,130 | A | 1986 Jan. 21 | Fredria Coates |
| 4,646,685 | A | 1985 Oct. 25 | Mary M. Arenz |
| 4,739,809 | A | 1988 Apr. 26 | Janice Adams |
| 4,800,677 | A | 1989 Jan. 31 | Robert J. Mack |
| 4,854,732 | A | 1989 Aug. 8 | Rino Italici |
| 4,872,420 | A | 1989 Oct. 10 | David Sheppard |
| 4,895,198 | A | 1990 Jan. 23 | Sydney W. Green |
| 4,974,893 | A | 1990 Dec. 4 | Paul E, Graham |
| 4,998,653 | A | 1991 Mar. 12 | Jeanette M. LaBelle |
| 5,002,401 | A | 1991 Mar. 26 | Marianne Blackman |
| 5,115,766 | A | 1992 May 26 | Ruth L. Williams |
| 5,178,426 | A | 1993 Jan. 12 | George Daus |
| 5,186,384 | A | 1993 Feb. 16 | Robert J. Nelson |
| 5,522,628 | A | 1996 Jun. 4 | Steve J. Fillis |
| 5,233,942 | A | 1993 Aug. 10 | Phyllis L. Cooper |
| 5,288,150 | A | 1994 Feb. 22 | Jodi Bearman |
| 5,350,045 | A | 1994 Sep. 27 | Jeffrey T. Robertson |
| 5,441,017 | A | 1995 Aug. 15 | Joseph Lindsey |
| 5,560,321 | A | 1996 Oct. 1 | Howard A. Hess |
| 5,713,616 | A | 1998 Feb. 3 | Jan B. Knutson |
| 5,718,192 | A | 1998 Feb. 17 | Arlin Sebastian |
| 5,727,500 | A | 1998 Mar. 17 | Meg Conboy |
| 5,779,290 | A | 1998 Jul. 14 | James A Wilkie |
| 5,813,445 | A | 1998 Sep. 29 | Lynn R Christman |
| 5,829,671 | A | 1998 Nov. 3 | Richard B. Hawk |
| 6,019,067 | A | 2000 Feb. 1 | Freddie Carrie |
| 6,073,590 | A | 2000 Jun. 13 | Janet Marie Armstrong Polding |
| 6,085,695 | A | 2000 Jul. 11 | LaRae Lee Miller |
| 6,273,481 | A | 2001 Aug. 14 | John Coulmbo, Frank DiLuzio |
| 6,471,267 | A | 2002 Oct. 29 | Katsuya Kkatz, Asazuma |
| 6,648,387 | B1 | 2003 Nov. 18 | Michael Kaplan |
| 6,964,247 | B2 | 2005 Nov. 15 | Hsun Chin Lin |
| 8,627,974 | B2 | 2014 Jan. 14 | Ajax Carl |

U.S. Patent Applications

| Publication | Kind | Publication | |
|---|---|---|---|
| number | Code | Date | Applicant |
| 20040200438 | A1 | 2004 Oct. 14 | Deborah Jeffrey |
| 20060032465 | A1 | 2006 Feb. 16 | Holly L. Valliant |
| 20090278365 | A1 | 2009 Nov. 12 | Arlene Hawks |
| 20040200438 | A1 | 2004 Oct. 14 | Deborah Lee Jeffrey |
| 20120286003 | A1 | 2012 Nov. 15 | Allison Ann Shadday |

### BACKGROUND OF THE INVENTION

1. Field of the Invention

The present invention relates to pet waste collection and disposal devices, and more specifically relates to an improved means of transporting used pet waste bags and carrying useful supplies for active pet owners.

The present invention relates to a portable low profile and light weight rectangular shaped pouch of flexible material designed to temporarily store and transport used pet waste bags in a convenient hands-free and sanitary manner. Three distinguishing features of this invention are one: the ability of the invention to be rolled down in size so it just accommodates the pet waste being carried, two: the invention also contains two leash attachments so the device can be attached to the leash in a manner that still allows vigorous pet/pet walker activities; three the inventions collapsible features, a collapsible side and a bottom section that closes flat allows the invention to foldup when not in use.

The collection and proper disposal of pet waste is a continuing concern as the growing number of pets. Many municipalities have regulations regarding the pickup of waste on walks for sanitary and “good neighbor” reasons. But the practice of picking up pet waste has made enjoyable walks with active dogs more difficult, cumbersome and socially awkward as pets need to relieve themselves and responsible pet owners have to hand carry soiled waste bags often for considerable distances. Moreover the inconvenience of pet waste handling makes it more difficult for running, extended walks, and generally active play for the pet owners. Unfortunately, this is frequently evidenced by sightings of filled pet waste bags left on public trails and sidewalks

2. Description of the Prior Art

The present invention addresses a void in current art. Current art concentrates on devices that scoop or automatically pickup pet waste and have various devices and methods for storing pet waste. The focus is on scooping up and disposing of pet waste in a sanitary manner. This invention uses standard pet waste bags but adds features that minimize the effort involved in carrying the pet waste bag before or after collecting pet waste, and allows for users to enter into more vigorous activities with their pet.

U.S. Pat. No. 5,713,616 to Knudson is for a purse like device that can fold up, has a device to pick up waste and a holder for the device that can pick up the pet waste as well as additional pockets. The product can compress in size and can be attached to a belt for easy carrying, or be carried over the shoulder, This device is not suitable for large amounts of pet waste, especially on long walks and does not collapsible.

U.S. Pat. No. 6,237,533 to Rodriquez is for a device that carries can carry fresh, unused bags for pet waste in one compartment, and filled waste bags in another. The invention is configured for independent use, or for use with a pet leash. A strap is provided, which functions to close the main compartment of the apparatus and to attach the apparatus to a pet leash. A handle strap is also provided for ease of carrying the apparatus by hand. The device doesn't have a way of stabilizing the bag on the leash, with only one end attached and is not meant for vigorous activity. The device also is not collapsible nor does it allow the device to reduced in size for small size pet deposits.

U.S. Pat. No. 8,627,974 to Francis is for a device that has two compartments to facilitate picking up multiple waste events, one compartment picks up the waste and the second compartment can take the waste deposit from the first compartment when a second waste event occurs. The device does not include an easy method of carrying the device on long or vigorous walks as it doesn't work for multiple waste deposits or have a method of securing the device after a deposit is made. This device also isn't collapsible.

U.S. Pat. No 4,974,893 to Grahn and U.S. Pat. No. 5,186,384 are devices that describe a tool for facilitating the transition of waste into a device and an integrated handle for carrying a device. The device does not include an easy method of carrying the device on long or vigorous walks, does not collapse.

U.S. Pat. No. 4,017,015 is another device that describes a collapsible device for the collection of pet waste. The device forms a scoop that facilitates the pickup of pet waste. This patent also consists of boxes that can flatten when not in use that offer storage space when filled for transporting to a disposal site. The device does not have an apparatus to allow the device to be attached to the dog lease for long walks but rather needs to be carried by hand.

U.S. Pat. No. 6,964,247 to Lin and U.S. Pat. No. 5,186,384 to Nelson and U.S. Pat. No. 4,566,130 to Migdal and U.S. Pat. No. 4,566,130 to Coates are canine waste collection devices with an easily detached bags when the bag is full. They do not have a collapsible feature or a method that easy carrying of the device that facilitates long and vigorous walks.

U.S. Pat. No. 3,885,266 to Nafziger device is for a pet litter scoop only.

U.S. Pat. No. 4,646,685 to Arenz is a combination carrying bag for infant accessories and U.S. Pat. No. 4,854,732 to Italici is a handbag with an external pocket for dispensing sheet material

U.S. Pat. No. 4,854,732 is a bag that floats but has external pockets for dispensing sheet like materials.

U.S. Pat. No. 4,739,809 to Adams and U.S. Pat. No. 5,178,426 to David are disposable kitty litter containers that dispense sheets.

U.S. Pat. No. 4,872,420 to Shepard and U.S. Pat. No. to Samuleson are disposable kitty litter devices

U.S. Pat. No. 4,974,893 to Grahn is money bag with a series of dispensing pockets.

U.S. Pat. No. 4,998,653 is a device that recovers waste and disposal kit for easily disposing waste. The device isn't collapsible, nor does it have a hands free method for carrying the device after pick-up off pet waste.

U.S. Pat. No. 5,002,401 to Blackman and U.S. Pat. No. 5,115,766 to Williams are devices that have concealable pouches and holding pockets that can be easily carried, but they don't have a method that facilitates easy carrying of device if they were used to pick up pet waste.

U.S. Pat. No. 5,186,384 to Nelson and U.S. Pat. No. 5,552628 to Fillis are disposable bag devices for pet excrement but don't include a waste pick up device.

U.S. Pat. No. 5,233,942 to Cooper is a disposable carton with scoop up device for pet waste but doesn't include a collapsible feature, or a apparatus to allow easy carrying of the device after waste pick-up.

U.S. Pat. No. 5,441,017 to Lindsay and Pat. No. 5,560,321 to Hess and U.S. Pat. No. 5,727,500 to Conboy and U.S. Pat. No. 5,779,290 to Wilkie are devices that hold pet waste and attaches to the dog leash. These devices attach with one connection and aren't suitable for use during vigorous activities.

U.S. Pat. No. 5,718,192 to Sebastian is a waste carrying device with pockets for holding pick-up devices and holding bags as well as a bag for holding bags full of pet waste.

U.S. Pat. No. 5,713,616 to Knudson relates to a device that dispenses litter bags from an animal harness. It doesn't have a method of holding pet waste after it is picked up nor is it collapsible.

U.S. Pat. No. 5,813,445 to Christman is a waste management system that rolls on the surface and provides a method of collecting waste and then easily disposing the waste but does not include collapsible features or an apparatus to allow hand free carrying of pet waste.

U.S. Pat. No. 6,073,590 to Polding is a carton formed into a pet litter scoop that can pick up waste and then be easily disposed.

U.S. Pat. No. 6,085,695 to Miller and U.S. Pat. No. 6,273,481 to Columbo are also devices that attach to dog leashes but that don't contain a double connection to the leash for vigorous activities nor are they completely collapsible.

U.S. Pat. No. 6,471,267 and is kit that cleaning up a disposing of pet waste. The product has pockets for empty bags but doesn't have anything relate to a attaching the device to a leash after the pet waste is picked up.

U.S. Pat. Application No. 20060032465 from Vallianti is a collapsible frame to capture and collect animal waste that can folded up and stored in a pocket. The product uses springs to open and has frame for holding a plastic bag. This device doesn't have a method of attaching the product to a leash and its pocket storage is only suitable for a pic up of small amounts of pet waste.

U.S. Pat. Application No. 20090278365 from Hawks relates to a device that intercepts pet waste before falling on the ground, but doesn't include a connection to a pet leash or collapsible features.

U.S. Pat. Application No. 20040200438 from Leeis a container device that is modified to pick up pet waste and dispose of it. It does not include connections to a pet leash, or collapsible features.

U.S. Pat. Application No. 20120286003 from Shadday is a device that stores empty waste collection bags and then can also store the used bags. This device does not include a hands free method of carrying the bags with pet waste nor does it have similar collapsible features.

From the brief description of some of the prominent prior art it is clear that none of the other devices focuses on: a method of attaching the pet waste disposal device to the leash with multiple points for stability during vigorous activities; along with a method of reducing the size of the bag when filled with pet waste to reduce the movement during vigorous activities. After reviewing prior art I conclude that the present invention prevents a solution to an important issue that is overlooked by other prior art, a device that allows for vigorous activity when the device has a bag of pet waste. The device is a compact device that can be attached to a pet leash in a stabilized and unobtrusive manner to facilitate extended pet walks, jogs, runs and other vigorous activities with pets.

### SUMMARY OF THE INVENTION

In accordance with one embodiment the invention is a portable, low profile, and lightweight rectangular shaped pouch of flexible material designed to temporarily store and transport used pet waste bags in a convenient, hands-free, and sanitary manner.

An object of the present invention is to provide a convenient means for rolling up the top of the disposal device so that it will have as small a profile as possible when containing pet waste.

Another object of the present invention is to have the device attach to a leash with two hook-like mechanisms that snap to the leash, one said hook-like mechanism in the middle of the device and one on the bottom of the device.

Anther object of the present invention is to have the device fold flat through the use of collapsible side panels and having a stiffening material hold the two sides together on the bottom of the device

Another object of the invention is to have stiffening material along the top front and rear panels to increase rigidity allowing the pouch to hold its shape better when depositing soiled pet waste bags.

Another object of the present invention is to provide a pet waste bag pocket attached to the front of the device to accommodate pet waste bags.

Another object of the invention is to provide a mechanism to hold a second pouch on the front on top of the pet waste bag pocket that can hold leash attachments and other pet oriented supplies

Another object of the invention is to provide loops near the top of the front and the back of the device. Said loops to be used to pull the device open so that filled waste bags can be easily inserted into the device.

Another object of the invention is to have a handle on the top of device so it can be easily carried if desired.

Another object of the invention is to provide a quick release handle attachment mechanism located on the front of the pouch projecting above the pet waste bag pocket. This quick release attachment mechanism is used to lock the bag in place after it is rolled down and then also act as handle for carrying the pouch.

Other objects, features, and advantages of the present invention will become apparent from the detailed description of the accompanying drawings.

### DRAWINGS

### Brief Description of the Drawings

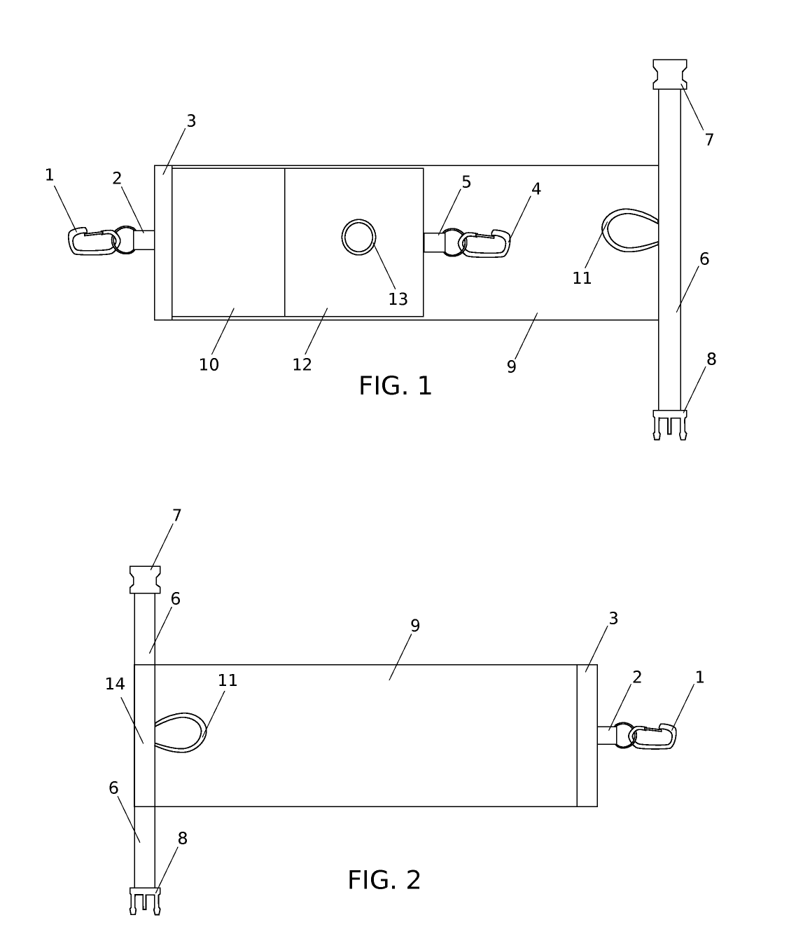

FIG. 1 is a view of the front of the device when laid flat and fully extended;

FIG. 2 is a view of the back of the device when laid flat and fully extended;

FIG. 3 is a perspective view of the device with the top of the device open;

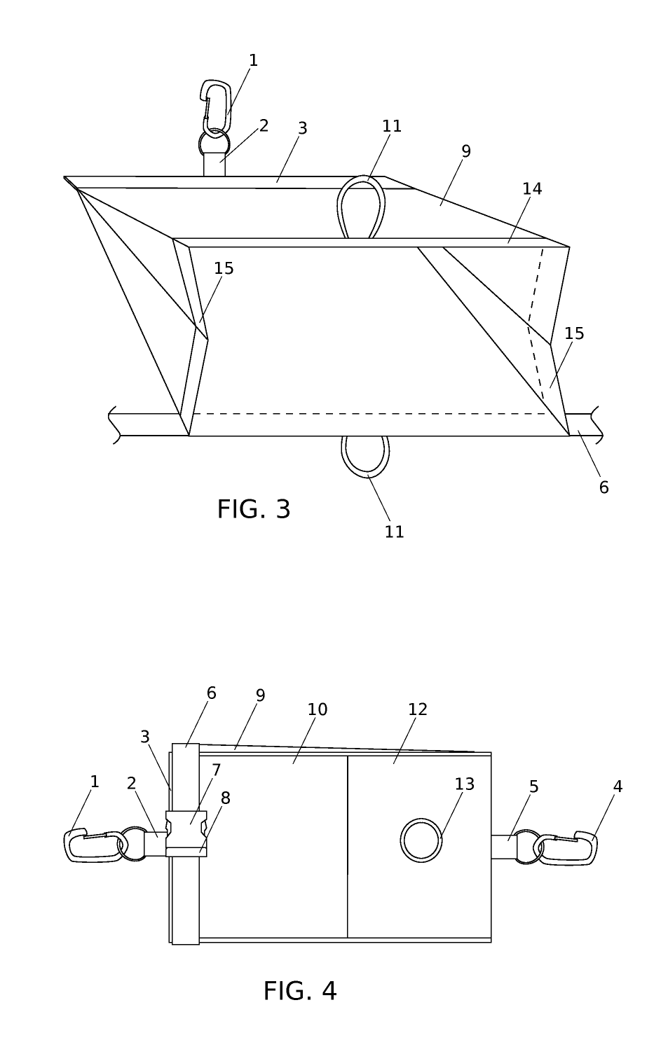

FIG. 4 is a view of the front of the device when folded in half;

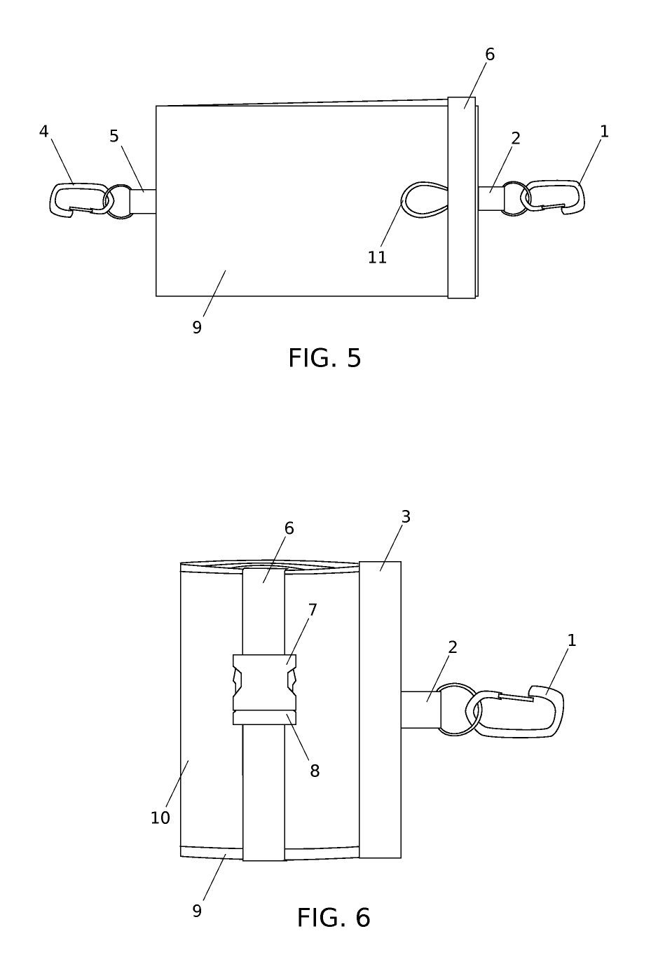

FIG. 5 is a view of the back of the device when folded in half;

FIG. 6 is a view of the device when rolled into its smallest form.

### DRAWINGS

### Reference Numbers

1. snap-on latching mechanism on the bottom of the device that can be attached to a leash
2. loop that is attached by a fabric to the bottom the device
3. stiffening material that holds the two collapsible sides together on the bottom of the device
4. second snap-on latching mechanism located in the middle of the device that can be attached to a leash
5. second loop that is attached by a fabric to the middle of the device
6. stiffening material on the top of the device that extends so that its ends can be folded over in order to seal the top of the device
7. female end of a locking mechanism to close the bag.
8. male end of a locking mechanism to close the bag when the stiffening material 6 is looped around the back side of device
9. side material of device that extends from the top to the bottom of device
10. accessory pocket that sits on top of the side material to hold pet accessories
11. attachment loops on front and back side of device that allow the device top to easily be pulled open
12. pocket that sits on top of side material for holding pet waste bags
13. hole in the pet waste pocket to facilitate removal of the pet waste bags
14. stiffening material on the back side of the bag to facilitate holding device open when depositing pet waste bags
15. Stiffening material on the side walls of the top of the device when depositing pet waste bags

### DETAILED DESCRIPTION OF THE INVENTION

The compact waste disposable device, the front of which is shown if FIG. 1-FIG. 3 is the preferred embodiment. FIG. 3 shows the rectangular device open top to accept used pet waste bags, and pleated side panels to allow for expansion when the pouch has contents. FIG. 1 shows how the device closes flat 3 to maintain its portable, low-profile, flat shape when the device is empty. A pet waste bag pocket 12 attached to the front panel of the device accommodates a roll of new pet waste bags or similar individual bags. In some embodiments pet waste bags may accessed through an opening in the pocket 12 for pet waste bags. Device embodiments may have additional accessory pocket(s) 10 to store various personal and pet training items.

The device is made of lightweight, durable, and spill resistant material 9 that increases portability and longevity while lowering maintenance and odors.

It has stiffening material along the top front 6 and top rear panels 14 to increase rigidity allowing the pouch to hold its shape better while depositing soiled pet waste bags. Device embodiments may include flexible magnets positioned on the top front and rear panels to assist in closing the top of the pouch and increase rigidity to the top opening.

A female quick release connectors 7 is attached to the one stiffening material on the front panel and a male quick release connector 8 is attached to the other side of the stiffening material 6. The connectors can be used, after rolling up the top of the device two or more times, to close the device to secure its contents and improve its portability by reducing its overall length. The quick release connectors allow the rolled up device to be carried like a handle thus improving sanitation by limiting users contact with soiled dog waste bags.

A pet waste bag pocket of flexible material 12 attached on the front exterior of the device carries a roll of pet waste bags or individual pet waste bags. The pocket, in its most basic form, has an opening at the top that closes and secures the bags as well as reinforced openings on one side and the front 13 to dispense individual bags. The pocket can be attached to the device in such a way as to provide a space between it and the device to accommodate lower leash attachment mechanisms. Additional embodiments of the pet waste bag pocket could have flap style or zipper closures.

The accessory pocket 10 of flexible material with a closable top can be attached to the front of the pet waste bag pocket and can accommodate pet training supplies, pet treats, hand sanitizers, and/or personal items like keys. Embodiments of the device can have additional accessory pockets placed behind the pet waste bag pocket for larger items like mobile phones, personal safety items, pet training supplies, and small lights.

A leash handle attachment loop 11 is located on the front of the device projecting above the pet waste bag pocket 12 to allow the device to be carried in a compact fashion when the top portion of the pouch is rolled down and connected around the pet waste bag pocket. The leash handle attachment loop 11 enables the device to be connected to leash handles by various means including but not limited to clips, and tethers. Embodiments of the leash handle loop have quick connectors to make the device easier and quicker to connect and release.

A lower leash attachment point 2 is located at the bottom of the device to minimize sway of the pouch when attached to a leash improving usability especially during more active outings with pets. Some device embodiments include a quick release connector 1 or a carabiner on the lower leash attachment point that allows for quicker attachment to the lower portions of the leash. The lower leash attachment point 2 also serves as a handle to empty the contents of the pouch into a garbage receptacle thus improving sanitation by minimizing user contact with soiled pet waste bags.

FIG. 3 illustrates how the device with collapsible sides attaches together at a single point on the bottom with a stiffening material 3 how the device opens on the top with stiffening material in the front of the device 6, stiffening material in the back of the device 14 and stiffening material on the sides 15. FIG. 3 also illustrates the use of the attachment loops 11 to hold the device open for the deposit of a waste disposal device.

We claim:

1. A portable, low profile and lightweight rectangular shaped sport pouch of flexible material designed to discreetly transport used pet waste bags and useful supplies. The sports pouch include the ability to be rolled down in size so it just accommodates the pet waste being carried, two leash attachments so the device can be attached to the leash in multiple locations and a collapsible side and a bottom section that closes flat allows the invention to foldup when not in use.

2. The apparatus of claim 1 with a “V” shape that allows the apparatus to be easily collapsed.

3. The apparatus of claim 1 that provides a rectangular top,

4. The apparatus of claim 1 with inwardly pleated sides, and a bottom sewn flat to allow the apparatus to be easily collapsed.

5. The apparatus of claim 1 providing collapsible side panels that facilitate the pouch folding flat while reinforcing the pouch at the bottom

6. The apparatus of claim 1 providing an upper leash attachment to hold the apparatus when full to the dog leash.

7. The apparatus of claim 1 providing an addition of a second leash attachment which further stabilizes the device when attached to a leash

8. The apparatus of claim 1 providing a method for folding the pouch to make the device ultra-compact and portable, a top half which can fold down securely to make the pouch more compact and unobtrusive

9. The apparatus of claim 1 providing the ability for the device to fold in half a second time which makes the device even more compact while still allowing access to supplies

10. The apparatus of claim 1 providing a roll down top that securely closes to make a handle, reduce odors, secure contents and provide an alternate leash attachment point for additional stability

11. The apparatus of claim 1 providing pockets attached to the outside of the main pouch of the apparatus that can be used to store a roll of or individual unused pet waste bags

12. The apparatus of claim 1 providing a second pocket that can hold leash attachments and other useful supplies

13. The apparatus of claim 1 providing finger loops at the top of the main pouch of the apparatus in the middle of the front and back panels to open pouch without having to place hands in potentially soiled areas containing used pet waste bags
